(19) United States
(12) Patent Application Publication
(10) Pub. No.: US 2008/0237204 A1
(43) Pub. Date: Oct. 2, 2008

(54) Laser Beam Machining Method for Printed Circuit Board

(75) Inventors: Goichi Ohmae, Ebina (JP); Hiroshi Aoyama, Ebina (JP); Masayuki Shiga, Ebina (JP); Shigenobu Maruyama, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebina-shi (JP)

(21) Appl. No.: 12/031,232

(22) Filed: Feb. 14, 2008

(30) Foreign Application Priority Data
Mar. 28, 2007 (JP) 2007-086081

(51) Int. Cl. B23K 26/38

(52) U.S. Cl. 219/121.69

(57) ABSTRACT

A laser beam machining method for a printed circuit board, for enabling to bring the depth of a bottom surface of grooves within an overlap region, which is irradiated with a laser beam, repetitively, to be nearly equal to that of the bottom surface of grooves within other regions, comprises the following steps of: fixing a line beam 4, which is shaped into a rectangular having a length sufficiently larger than its width, in a cross-section perpendicular to a central axis thereof; executing a belt-like machining on a certain region of the printed circuit board 6, while moving a mask 1 and the printed circuit board 6 in opposite directions, in a direction of the width of the line beam 4 (i.e., X-direction); and thereafter moving the mask 1 and the printed circuit board 6, relatively, into a direction perpendicular to the belt-like machining direction, and repeating the belt-like machining upon other region, newly, thereby machining a groove on the printed circuit board 6, wherein when repeating the machining overlapping the regions, the machining is conducted with using the line beam 4 being shaped to be oblique on its overlapping side, to be overlapped on that region.

### BACKGROUND OF THE INVENTION

The present invention relates to a laser beam machining method for a printed circuit board.

For forming gutters or grooves for a wiring pattern on the printed circuit board, trials are made to produce wiring patterns with using an excimer laser (hereinafter, being called “ablation processing”), the shape whose beam (hereinafter, being called “beam shape”) has a rectangular shape in cross-section (hereinafter, being called “line beam”) (see the following Non-Patent Document 1). In this ablation processing, scanning is made on a mask and a board or substrate, at the same time, with respect to the laser beam, the position of which is fixed.

Also, in case of the lithography exposure, i.e., exposing a large sized wiring pattern on a substrate of semi conductor silicon, etc., in a similar manner to that of the ablation processing, after moving a mask and the substrate with respect to a fixed irradiation beam, and thereby executing a belt-like exposure in the longitudinal direction, within a certain area or region of the substrate, then the substrate is moved in the transverse direction, so as to repeat the exposure on a new area or region, and thereby achieving the exposure on the substrate as a whole. In this instance, there is already known a technology for making joints unremarkable (see the following Patent Document 1), by exposing the joint portions between the exposure areas or regions, complementarily, while bringing the cross-section of the irradiation beam into a hexagon. According to this technology, it is possible to make the exposure at the joint portion nearly equal to that of other portions.

[Patent Document 1] Japanese Patent Laying-Open No. Hei 2-229423 (1990); and

[Non-Patent Document 1] Phil Rumsby, et al., Proc. SPIE Vol. 3184, pp 176-185, 1997.

### BRIEF SUMMARY OF THE INVENTION

Although the technology shown in the Patent Document 1 is effective, however since it is impossible to bring a displacement at the joint portion to be zero (0), from a practical viewpoint, therefore it is necessary to provide a margin for overlapping. Though ill influences are small under the lithography exposure, which are given by a displacement of the irradiation position and/or by a change of the irradiation intensity, but on the contrary thereto, a displacement the irradiation position gives ill influence, directly, upon the groove configuration formed under the ablation processing.

An object, according to the present invention, is to provide a laser beam machining method for a printed circuit board, for enabling to make the depth down to the bottom of the groove within a region where irradiated with the laser light in an overlapping way (hereinafter, being called an “overlap region”), nearly equal to that within other regions.

For overcoming the drawbacks mentioned above, according to the present invention, there is provided a laser beam machining method for a printed circuit board, comprising the following steps of: fixing a laser beam, which is shaped into a rectangular having a length sufficiently larger than its width, in a cross-section perpendicular to a central axis thereof; executing a belt-like machining on a certain region of said printed circuit board, while moving a mask and the printed circuit board in opposite directions, in a direction of the width of said laser beam; and thereafter moving said mask and said printed circuit board, relatively, into a direction perpendicular to the belt-like machining direction, and repeating the belt-like machining upon other region, newly, thereby machining a groove on said printed circuit board, wherein when repeating the machining overlapping said regions, the machining is conducted with using said laser beam being shaped to be oblique on its overlapping side, to be overlapped on said region.

In this instance, within the laser beam machining method as described in the above, it is practical that an angle for defining said overlapping side to be oblique is from 91 degrees to 175 degrees in one of internal angles defined by said longer side and the oblique side.

Also, within the laser beam machining method as described in the above, it is practical that said laser beam for use of conducting a machining on said overlap region afterwards is so positioned that a trajectory of the middle point of said oblique side thereof is shifted to a side of said region, upon which a previous machining is treated, by a predetermined distance from the trajectory of the middle point of the oblique side of said laser beam, which is used for said previous machining.

And also, within the laser beam machining method as described in the above, it is practical that an edge portion of said rectangular laser beam is defined by means of light-shielding plates, which are disposed apart by a predetermined distance from said mask in a direction of the central axis of said laser beam.

According to the present invention mentioned above, it is possible to bring the total amount of irradiation light upon the overlap region to be nearly equal to that on other regions, and therefore enabling the uniform machining of grooves.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a schematic view for showing the feature of an excimer laser machining machine, in which the present invention can be applied, preferably;

FIG. 2 is a plan view showing a shape of irradiated area of a line beam;

FIGS. 3(a) and 3(b) are views for showing the relationship between the disposition of the line beam and a machined configuration; and

FIGS. 4(a) and 4(b) are views for explaining the disposition of light-shielding plates.

### DETAILED DESCRIPTION OF THE PREFERRED EMBODIMENTS

Hereinafter, embodiments according to the present invention will be fully explained by referring to the attached drawings.

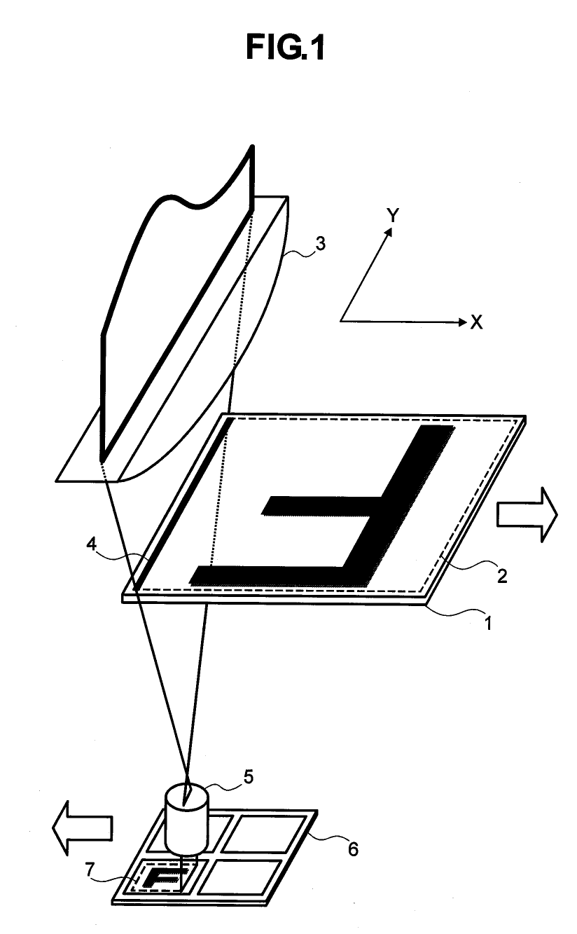

FIG. 1 is a schematic view for showing the feature of an excimer laser machining machine, in which the present invention can be applied, preferably.

As the laser beam of the excimer laser, a beam produced by a laser oscillation is shaped into a rectangular beam (hereinafter, being called a “line beam 4”), being uniform in distribution of the beam intensity, with using a homogenizer (i.e., a beam intensity distribution shaping device), and it is output in a pulse manner. The line beam 4 is condensed upon a mask 1, into a rectangular shape having a length of 130 mm and a width of 6 mm, by a cylindrical lens 3, and thereby being incident upon the mask 1.

The material of the mask is quartz glass, on one side surface of which is coated or applied chromium. However, the chromium coated is scratched or removed in portions where the line beams 4 should penetrate through, i.e., a portion having similar configuration (herein, enlarged 5 times) to that of a conductor pattern to be processed. In this embodiment, an area or region 2 (hereinafter, being called “pattern size”) on the mask 1, being indicted by dotted lines in the figure, where the chromium is removed, has sizes 125 mm×125 mm. The mask 1 can move freely, i.e., into the direction of the width (X-direction) of the line beam 4 and the direction of the length (Y-direction) of the line beam 4 by means of a moving means, illustration of which is omitted herein, while an impinging position of which is fixed.

A projection lens 5 is so positioned, that a diameter thereof corresponds to the longer side of the line beam 4, and also that a central axis thereof is in coaxial with the central axis of the line beam 4.

A printed circuit board 6 is fixed on a table, the illustration of which is omitted in the figure, and it can move freely, in the X-direction and the Y-direction, by means of the moving means, illustration of which is also omitted herein.

In case of this embodiment, since a reduction ratio is five (5) times, therefore, the sizes of the pattern 7 shown by the dotted lines on the printed circuit board 6 are 25 mm×25 mm.

Next, explanation will be made on the steps of the processing.
A. In case where the width of a pattern on the mask 1 is equal to 125 mm or less than that, in the Y-direction.

In this case, the line beam 4 is equal or greater than the pattern width. Then, while moving the mask 1 in the positive X-direction at a moving velocity “Vs” with respect to the line beam 4 and the projection lens 5 which are fixed, and also moving (or, scanning) the printed circuit board 6 in the negative X-direction at a moving velocity “Vs/5”, grooves and holes 5 are processed on the printed circuit board 6, by reducing and transcribing the conductor patterns, which are formed on the mask 1, upon the surface of the printed circuit board 6 (hereinafter, being called “scan process”). In this case, since the reduction ratio is five (5) times, then the sizes of pattern 7, which is reduced and transcribed on the printed circuit board 6 shown by the dotted lines on the same figure, are 25 mm×25 mm or less than that.
B. In case where the width of a pattern on the mask 1 exceeds 125 mm, in the Y-direction.

In this case, the line beam 4 is less than the pattern size. Then, the region upon which is irradiated with the laser is divided in the Y-direction. Hereinafter, explanation will be made on a method for dividing the processing region. (Hereinafter, being called “overlap processing”.)

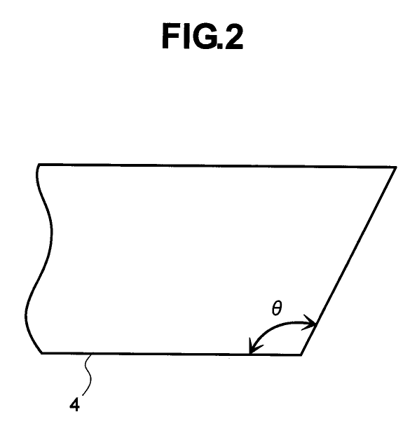

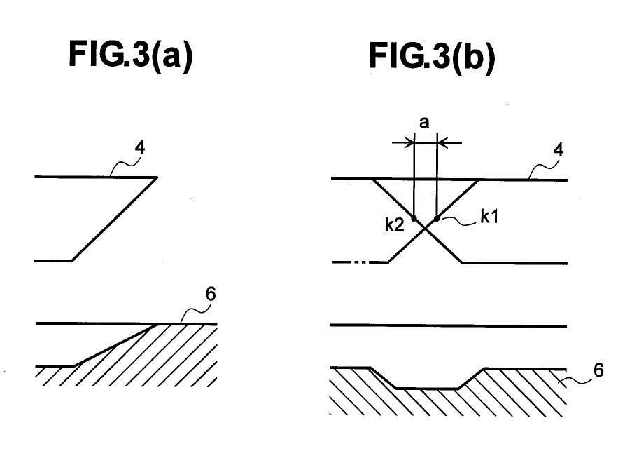

FIG. 2 is a plan view showing a shape of irradiated area (beam shape) of the line beam 4, and FIGS. 3(a) and 3(b) are drawings for showing the relationship between the beam shape of the line beam 4 and the machined or processed structure, wherein the beam shape is shown in an upper stage thereof while the cross-section of the printed circuit board 6 processed.

As is shown in FIG. 2, when overlapping the processing regions, the overlapping side of the line beam 4 is shaped to be inclined or oblique. In this instance, an internal angle “θ” defined by containing the longer side and the shorter side of the line beam 4 therebetween is determined within the range from 91 degrees to 175 degrees. Further, since the line beam 4 is oblong in the shape, then another internal angle comes to 5 degrees to 89 degrees. Hereinafter, the side, on which the line beam 4 is shaped to be oblique, it is called “shaped side”.

As is shown in FIG. 3(a), first of all, a first machining is executed. A machining portion, which is irradiated with the shaped side, comes to be shallow, gradually. Next, as is shown in FIG. 3(b), a second machining is conducted, so that a trajectory of the middle point “k2” on the shaped side in this time comes to the side of the first machining by a distance “a”, with respect to the trajectory of the middle point “k1” on the shaped side when conducting the first machining. Herein, the distance “a” is a sum of the maximum values of tolerances or allowances, when positioning the mask 1 and the printed circuit board 6 in the Y-direction.

As is shown in FIG. 3(b), because of excessive supply of processing or machining energy thereon, the bottom surface of grooves, which is formed within the overlap region, comes to be deeper than that formed within other regions, but the difference is very small. And, by increasing the angle “θ”, it is possible to reduce or lessen the difference in the depth direction.

Next, explanation will be made on a method for forming the shaped side.

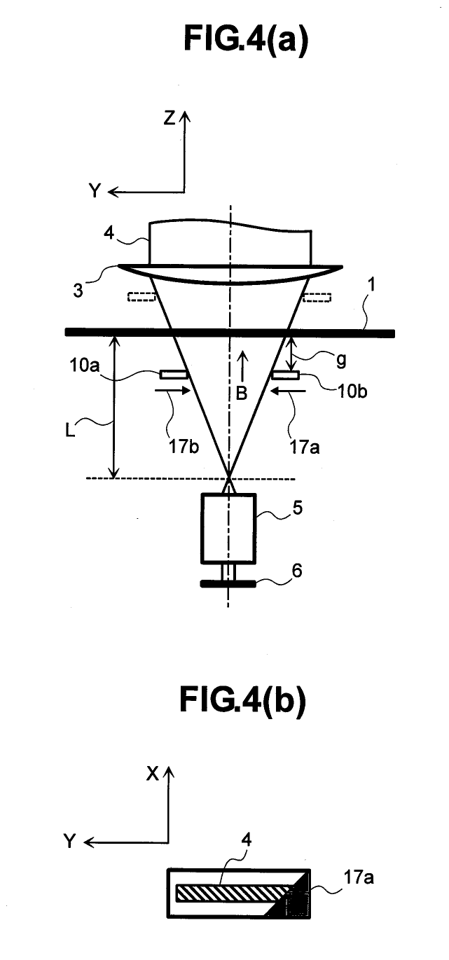

FIGS. 4(a) and 4(b) are views for explaining the disposition of light shielding plates, wherein FIG. 4(a) shows a side view thereof in vicinity of the mask and FIG. 4(b) a view along the arrow “B” in FIG. 4(a).

With shielding a part of the line beam 4 by light-shielding plates 17a and 17b, each being made of metal, it is possible to build up the shaped side. However, in case when building up the shaped side on the right-hand side of the line beam 4 in the figure, the light-shielding plate 17a is used, while the light-shielding plate 17b is used when building up the shaped side on the left-hand side thereof.

Further, in those figures, though the light-shielding plates 17a and 17b are disposed in the side of the projection lens 5 with respect to the mask 1, but they may be disposed in the side opposite to the projection lens 5, as shown by the dotted lines in FIG. 4(a).

Next, explanation will be made on a distance “g” between the light-shielding plates 17a and 17b and the mask 1.

When disposing the light-shielding plates 17a and 17b close to the mask 1, since images of edges of the light-shielding plates 17a and 17b are formed on the printed circuit board 6, then there may be a case of generating a stripe-like pattern on the bottom surface of grooves within the overlapping region. Though the height difference is very small between the bottom surfaces of grooves building up the stripes, but it results in a cause of reason of loosing or lowering the reliability in machining quality. In such case, if disposing the light-shielding plates 17a and 17b apart from the mask 1, the images of the light-shielding plates 17a and 17b are formed at the position apart from the surface of the printed circuit board 6. Thus, the boundary between the overlapping portion and others comes to be small, and therefore it is possible to make it almost invisible when seeing it by eyes.

Hereinafter, explanation will be made on the embodiment in more details thereof.

### Embodiment 1

An overlap processing is conducted under the machining condition for obtaining the grooves with the width 10 μm, at a distance 10 μm between the neighboring grooves, and in depth 10 μm, on the printed circuit board 6, by using fifteen (15) pulses of the excimer laser, having a wavelength of 308 nm, a pulse width of 40 ns, an energy density of 0.85 J/cm² and operating at a pulse repetition ratio of 50 Hz, for example. The angle “θ” is 100° and the distance “g” is 20 mm, in a lower side of the mask 1.

Further, the numerical aperture of the projection lens 5 is 0.1, and the distance “L” from the mask 1 to the front-side focus point of the projection lens 5 is 750 mm.

In this case, when setting the distance “a” to be 1.7 mm, being greater than the sum of the maximum values of tolerances in positioning the mask 1 and the printed circuit board 6 in the Y-direction, then no stripe-like pattern is generated on the bottom surface of grooves within the overlap portion; i.e., it is possible to make the depth of machining be uniform. Further, it can be also confirmed that the distance “g” of being equal or greater than 10 mm may be used.

Moreover, this machining method is applicable, generally, for all kinds of laser beams having the characteristics of incoherent light (in particular, suitable for the excimer laser).

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A laser beam machining method for a printed circuit board, comprising the following steps of:
fixing a laser beam, which is shaped into a rectangular having a length sufficiently larger than its width, in a cross-section perpendicular to a central axis thereof;
executing a belt-like machining on a certain region of said printed circuit board, while moving a mask and the printed circuit board in opposite directions, in a direction of the width of said laser beam; and thereafter
moving said mask and said printed circuit board, relatively, into a direction perpendicular to said belt-like machining direction, and repeating said belt-like machining upon other region, newly, thereby machining a groove on said printed circuit board, wherein
when repeating the machining overlapping said regions, the machining is conducted with using said laser beam being shaped to be oblique on its overlapping side, to be overlapped on said region.

2. The laser beam machining method, as described in the claim 1, wherein an angle for defining said overlapping side to be oblique is from 91 degrees to 175 degrees in one of internal angles defined by said longer side and the oblique side.

3. The laser beam machining method, as described in the claim 1, wherein said laser beam for use of conducting a machining on said overlap region afterwards is so positioned that a trajectory of the middle point of said oblique side thereof is shifted to a side of said region, upon which a previous machining is treated, by a predetermined distance from the trajectory of the middle point of the oblique side of said laser beam which is used for said previous machining.

4. The laser beam machining method, as described in the claim 1, wherein an edge portion of said rectangular laser beam is defined by means of light-shielding plates, which are disposed apart by a predetermined distance from said mask in a direction of the central axis of said laser beam.
